(19) United States
(12) Patent Application Publication
(10) Pub. No.: US 2025/0305172 A1
(43) Pub. Date: Oct. 2, 2025

(54) ALUMINIUM SMELTING METHOD & APPARATUS

(71) Applicant: ENPOT HOLDINGS LIMITED, Invercargill (NZ)

(72) Inventor: Nicholas Brian DEPREE, Auckland (NZ)

(73) Assignee: ENPOT HOLDINGS LIMITED, Invercargill (NZ)

(21) Appl. No.: 18/881,219

(22) PCT Filed: Apr. 13, 2023
(86) PCT No.: PCT/NZ2023/050043

§ 371 Date: Jan. 3, 2025

(30) Foreign Application Priority Data
Jul. 8, 2022 (NZ) 790164
Jan. 26, 2023 (NZ) 796703

(51) Int. Cl. C25C 3/20; C25C 3/08

(52) U.S. Cl. CPC C25C 3/20; C25C 3/08

(57) ABSTRACT

A carbon lined pot having a metal shell for smelting aluminium, has a plurality of temperature sensors situated on the exterior of the metal shell, a plurality of suction heat exchangers on the exterior of the metal shell, with each heat exchanger located in proximity to and enclosing one of the temperature sensors and capable of providing localized cooling, at least a portion of the exterior of each heat exchanger is insulated to reduce heat loss therefrom, and means for monitoring the temperature sensors and means for controlling the localized external cooling by controlling the amount of ambient air drawn into the open bottom of the heat exchanger and drawn through an outlet conduit.

### FIELD OF THE INVENTION

The invention relates to improvements in ALUMINIUM SMELTING.

### BACKGROUND OF INVENTION

Aluminium smelting is complex electrolytic process on a large scale using a number of large pots (e.g., 100 to 1000 pots per smelter or more) each pot containing from 5 to 10 tons of electrolyte containing dissolved alumina which is reduced to create liquid aluminium. The internal temperature of each pot should be in excess of 950° C. Whilst it is customary practice to refer to an “electrolytic cell”, in the industrial production of aluminium, the terms “pot” is used to describe the largescale electrolytic cell and a collection of them is designated a “potline”.

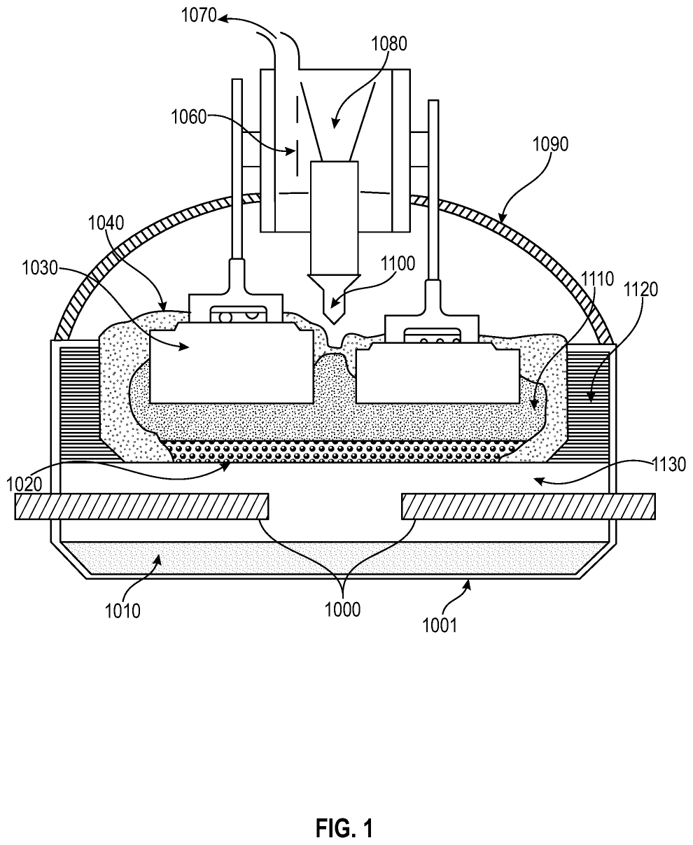

To give some idea of scale, traditional pots would be of the order of 10 m×5 m in plan, and 1.8 m deep (about the size of a backyard swimming pool). But the overall height is much greater with the superstructure on top (See FIG. 1). This is a common size, but newer and larger pots will be longer, maybe double this size. Typical superstructure might be another 2 m at least on top. The depth of 1.8 m includes support bracing around the shell, the actual ‘box’ containing refractory bricks might only be 1 m deep, with the liquid only 0.5 m deep above the carbon cathodes.

All commercial production of aluminium is based on the Hall-Heroult smelting process in which the aluminium and oxygen in the alumina are separated by electrolysis. This consists of passing an electric current through a molten solution of alumina dissolved in cryolite (sodium aluminium fluoride) with other additives. The molten solution is contained in reduction cells or pots which are lined at the bottom with carbon (the cathode) and are connected in an electrical series called a potline. Inserted into the top of each pot are carbon anodes, the bottoms of which are immersed in the molten solution.

The passage of an electric current causes the oxygen from the alumina to combine with the carbon of the anode to form carbon dioxide gas. The remaining molten metallic aluminium collects at the cathode on the bottom of the pot. Periodically, it is siphoned off and transferred to large holding furnaces. Impurities are removed, alloying elements added, and the molten aluminium is cast into ingots or other forms.

The smelting process is a continuous one, but which is operated batchwise with respect to inputs and outputs, with consumed anodes being replaced periodically. As the alumina content of the cryolite bath is reduced, more alumina is added. Heat generated by the passage of the electric current maintains the cryolite bath in its molten state so that it will dissolve the alumina. A great amount of energy is consumed during the smelting process; typically, from 13,000-16,000 kilowatt hours of electrical energy is needed to produce one tonne of aluminium from about two tonnes of alumina.

Controlling aluminium production is difficult as the internal dynamics of each pot in a potline is difficult to determine and the effective temperature range is narrow. It is difficult to determine if one or more pots is “sick” (not operating effectively) and especially the root causes thereof.

Aluminium smelting is the process of extracting aluminium from its oxide, alumina, generally by the Hall-Heroult process. Alumina is in turn extracted from the naturally occurring ore bauxite.

Aluminium smelting is complex electrolytic process on a large scale, so an aluminium smelter uses huge amounts of electric power; typically, 150,000 Amps to 500,000 Amps per pot at 4.0 to 4.5 volts. Heat generation is controlled by the operating current (usually fixed but able to be varied on a potline basis) and the anode-cathode distance which determines the effective electrical resistance of the pot.

Consequently, smelters tend to be located close to large power stations, often hydro-electric ones, in order to hold down costs and reduce the overall carbon footprint. Smelters are often located near ports, since many smelters use imported alumina.

The Hall-Heroult electrolysis process is the only common production route for primary aluminium. An electrolytic cell (typically called “a pot”) is made of a steel shell with a series of insulating linings of refractory materials. The cell consists of a brick-lined outer steel shell as a container and support. The outer steel shell is supported on external metal cradles.

Inside the shell, cathode blocks are cemented together by ramming paste or glue. The top of each cathode block is in contact with the molten metal, where the metal acts as the electrical cathode. The molten electrolyte is maintained at high temperature inside the cell.

As the alumina is reduced, the molten aluminium forms a liquid layer adjacent the bottom of the pot (i.e., laying on the cathode blocks). FIG. 1 is a schematic showing the typical components of a pot containing alumina and molten aluminium.

There is a temperature gradient from the hot interior of the pot to the cool exterior of the pot, so some of the electrolyte freezes at the edge of the bath resulting in a protective layer protecting the refractory material and the steel side walls.

In practice the temperature of the molten electrolyte needs to be maintained at about 960-970° C. for optimum process efficiency. If the internal temperature of the molten electrolyte drops below the freezing point (the liquidus temperature, typically around 950-960° C.), then the pot will stop operating and need to be repaired. The electrolyte will typically be operated with around 10° C. of superheat i.e., 10° C. above the liquidus or freezing point.

The anode is also made of carbon in the form of large, calcined, vibroformed blocks suspended in the electrolyte. A single Soderberg electrode or a number of prebaked carbon blocks are used as the anode, while the principal formulation and the fundamental reactions occurring on their surface are the same.

An aluminium smelter consists of a large number of pots in which the electrolysis takes place. A typical smelter contains anywhere from 200 to 1000 pots, each of which produces in excess of a tonne of aluminium a day, though the largest smelters are now up to five times that capacity.

Smelting is currently run as a continuous process, with the aluminium metal deposited at the bottom of the pots and periodically siphoned off. After each (infrequent) shut down of a pot the complete refractory lining and cathodes are replaced, and the pot shell repaired.

Smelters are sometimes of necessity used to control electrical network demand by shutting down whole potlines for periods of months, and as a result power may be supplied to the smelter at a lower price. However, under normal circumstances power must not be interrupted to the potline for more than 4-5 hours since then all the pots freeze their electrolyte and have to be dug out, repaired and restarted at great cost. The power demand of a smelter is many hundreds to thousands of Megawatts and changes to the supply current can result in unwanted cooling or freezing of the pots. A typical pot will contain from 5 tons to 10 tons of electrolyte and 5 tons to 10 tons of liquid aluminium at temperature above 950° C.

The electrolyte is a molten bath of cryolite (Na3AlF6) and dissolved alumina with other additives. Cryolite is a good solvent for alumina with low melting point, satisfactory viscosity, and low vapour pressure. Its density is also lower than that of liquid aluminium (2.05-2-10 vs 2.3 g/cm3), which allows natural separation of the product from the salt at the bottom of the cell. The cryolite ratio (NaF/AlF3) in pure cryolite is 3, with a melting temperature of 1010° C., and it forms a eutectic with 11% alumina at 960° C. In industrial cells the cryolite ratio is kept between 2 and 3 to decrease its melting temperature to 940-980° C.

Carbon cathodes are positioned at the bottom of each cell/pot. Carbon cathodes are essentially made of anthracite, graphite and petroleum coke, which are calcined at either 1200° C. for semi-graphitic cathodes or at 2000 deg C. plus for graphitized cathodes and crushed and sieved prior to being used in cathode manufacturing. Aggregates are mixed with coal-tar pitch, formed, and baked. Carbon purity is not as stringent as for anodes, because metal contamination from cathodes is not significant. Carbon cathodes must have adequate strength, good electrical conductivity and high resistance to wear and sodium penetration. Anthracite and semi-graphitic cathodes have higher wear resistance and slower creep with lower amplitude than graphitized petroleum coke cathodes. Instead, graphitized cathodes with more graphitic order have higher electrical conductivity, lower energy consumption, and lower swelling due to sodium penetration. Swelling results in early and non-uniform deterioration of cathode blocks.

Carbon anodes have a specific situation in aluminium smelting and depending on the type of anode, aluminium smelting is divided in two different technologies: “Soderberg” and “prebaked” anodes. Anodes are also made of petroleum coke, mixed with coal-tar-pitch, followed by forming and baking at elevated temperatures. The quality of anode affects technological, economic and environmental aspects of aluminium production.

Inhomogeneous anode quality due to the variation in raw materials and production parameters also affects its performance and the cell stability. Anodes sit above the pot and are lowered into the pot as they are consumed.

The very large current draw by each pot results in large internal magnetic fields and this can result in magnetohydrodynamic forces causing metal heave and metal waves in the molten aluminium pool. If the aluminium pool then touches the anode, the pot will short circuit at that point. This instability places a practical limit on the Anode-Cathode distance.

Heat and the corrosive environment, as well as the presence of strong electrical potentials (up to 1500 volts) and magnetic fields will limit the types of materials that can be used in or near the pots. For example, it is not possible to use water or other liquid electrical conductors near pots or on the potline building.

Aluminium smelting as a metallurgical process has a well-known problem of a lack of observability of many key process parameters relating to process efficiency, or process stability and mechanical integrity. The pots are situated on or under the floor and covered with gas hoods. Access to the pots is difficult.

One of the key parameters is the temperature of the liquid solvent (the molten electrolyte) and the freezing point of the solvent (the liquidus temperature) inside the cell, both of which are now measured but only once every two days because of the large numbers of cells to be controlled independently. Furthermore, these temperature measurements are localised to one point in the cell and give no indication of temperature distributions. They are not very effective in monitoring cell temperature trends on a short-term basis. The external temperature of cells (on the steel ‘shell’) is not routinely or commonly measured at all, other than for cause when another failure risk factor is identified, such as a red-hot steel plate, high electrolyte temperature, or electrolyte leaking from the shell or through the collector bars and can be difficult to access for measurement.

Problems with the control of electrolyte temperature can result in low efficiency of the electrochemical process and can also cause mechanical cell failures including ‘tap outs’ when the refractory lining and steel shell are corroded by the liquid solvent (cryolite), and the cell suffers a catastrophic and potentially dangerous failure where the liquid metal and bath leak out of the cell. This results in increased costs due to early replacement of the cell, clean-up of spilled material, and potential replacement of other components that may have been damaged.

Process excursions internal to the cell can cause elevated liquid temperatures and rapid melting of the frozen ‘ledge’ which protects the refractory sidewalls from attack and eventual failure. Once these temperatures are identified they may be dealt with, but the time lag can be considerable before the problem is identified and action can be taken.

Other issues with cell design, or changes due to age and accumulated damage, may also cause problems with temperature distribution such as hot or cold areas, particularly towards the ends of cells. These can cause process efficiency issues including degraded current distribution around the cell when some anodes do not carry enough current, causing further problems with current efficiency.

Identification of elevated or lowered liquid temperatures is routinely done but only daily or less frequently. On a shorter time frame, the key measurements able to identify process excursions are the cell voltage, and voltage noise, as well as sporadic ‘anode effects’—these measurements can indicate other problems in the cell, which stimulate process engineers belatedly to make more detailed investigations of problem cells, during which they may identify process problems causing elevated or lowered internal temperature.

In extreme cases elevated internal temperatures causing refractory damage may result in external pot shells eventually glowing red, prompting emergency actions. At this time, a lance blowing compressed air at the affected hot point on the shell may be temporarily or permanently installed to locally cool that part of the shell. A key issue with this corrective action is that the temperature problem is not identified until major damage has already been caused to the refractory lining to cause red-hot shell temperatures.

The installation of compressed air lances may effectively cool the local area and prevent catastrophic cell failure, but is an unsustainable solution operationally and financially for the following reasons:
Only a limited number of lances are available to the plant.
Compressed air delivery at all times to the pot is an extremely large expense.
Compressed air delivery can be noisy and an additional noise safety hazard.
Compressed air lances and air lines are an additional tripping hazard.
The equipment must be physically moved to location and installed as needed and may stay there for the remaining life of the cell.
A network of air lances and piping called a Forced Cooling Network (FCN) has been implemented by one producer (Riotinto Alcan) on their AP30-40 potline technologies. This FCN suffers from the deficiencies above for compressed air lances and in addition have no feedback from the cells to the process control system for the potline, e.g., on the thermal status of the cell or the shell wall.
All of the above equipment can only be used for cooling of the shell of cells, and not their thermal regulation or control.

### Prior References

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that any of these documents form part of the common general knowledge in the art, in New Zealand or in any other country.

### Definitions

Anode: these are made of carbon and are situated above the pot and can be lowered into contact with the electrolyte. Two different types of anode are commonly used: (1) “Soderberg” and (2) “prebaked” anodes.

Anode spike: A defect in the anode resulting in a huge local increase in current flow and heat generation. This local heating can cause rapid local melting of the protective ledge and hence damage to the adjacent refractory material.

Cathode: Typically made up of carbon blocks positioned at the bottom of each cell/pot.

Comprise: It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process.

Forced Air: As used herein it refers to air being sucked through or pushed through a duct or container, typically by a fan.

Pot: An industrial electrolytic cell used to convert alumina to liquid aluminium.

Potline: A collection of pots in an aluminium smelter.

### OBJECT OF THE INVENTION

It is an object of the invention to provide an improved method of smelting aluminium and/or improved apparatus that ameliorates some of the disadvantages and limitations of the known art or at least provide the public with a useful choice.

### SUMMARY OF INVENTION

In one aspect the invention proves a method of smelting aluminium in an electrolytic pot, comprising:
providing a plurality of temperature sensors on or adjacent the shell of the electrolytic pot, providing a plurality of heat exchangers each heat exchanger located in proximity to one of the temperature sensors,
each heat exchanger at least partially insulating the pot shell to reduce heat loss therefrom, wherein flow of a coolant fluid through the heat exchanger will cool an adjacent portion of the pot shell and reducing or interrupting the flow of the coolant fluid through the heat exchanger will allow heat to build up in the heat exchanger, monitoring the temperature sensors and if the temperature at a first sensor is above a first threshold value, increasing the flow of the coolant fluid through the adjacent heat exchanger or some number of adjacent heat exchangers, and if the temperature is below a second threshold value, reducing or stopping the flow of the coolant fluid through the heat exchangers.

More preferably the or each temperature sensor is mounted on an exterior wall of the pot.

Preferably each heat exchanger surrounds a temperature sensor.

Preferably the coolant fluid is air.

Preferably the flow of air is controlled by a valve, more preferably, when fully closed it prevents egress of the air escaping from the heat exchanger.

Preferably the air is drawn (i.e., forced) through the heat exchangers by a suction fan.

If the airflow is reduced or stopped this allows the air trapped inside the heat exchanger to provide a degree of insulation for the adjacent area of the pot shell, as the air cannot escape from the heat exchanger, due to the close fitment and sealing of the boundaries of each heat exchanger against the steel shell of the electrolytic pot.

More preferably there is an insulating layer on the outside of the heat exchanger-either formed by a box of stagnant air or by a box containing a heat resistant insulating material.

Less desirably the air could be forced through the heat exchanger by the use of compressed air or a fan or fans pushing the air through the heat exchangers.

Preferably all heat exchangers cover the relevant portion/height of the pot shell sidewall where the molten liquids are contained. In some highly thermally conductive pot technologies with graphitised cathodes and/or copper collector bars it is preferable for the heat exchangers to also insulate part of the lower shell adjacent to these conductive cathode assemblies.

In another aspect the invention proves a method of smelting aluminium in an electrolytic pot, comprising:
providing a plurality of temperature sensors on or adjacent the shell of the electrolytic pot,
providing a plurality of heat exchangers each heat exchanger located in proximity to one of the temperature sensors to provide localised cooling of the shell of the pot, insulating at least a portion of the exterior of the shell of the electrolytic pot with heat exchangers to reduce heat loss therefrom,
monitoring the temperature sensors and if the temperature is above a first threshold value, increasing the localised external cooling, and if the temperature is below a second threshold value, reducing or stopping the localised external cooling.

Preferably each heat exchanger covers the relevant portion/height of the pot shell sidewall where the liquid is contained and could also extend downwardly to the region of the carbon cathode.

Preferably each heat exchanger surrounds a temperature sensor.

Preferably the outermost wall of the heat exchanger is insulated. That is the wall furthest from the pot shell.

Preferably at least some of the heat exchangers have forced air cooling ducts so that control of the airflow controls the amount of heat extracted from that locality of the pot.

Preferably the heat exchangers are air suction heat exchangers which maintain their suction through high quality sealing against the steel shell of the electrolytic pot.

Preferably the heat exchangers have a plurality of ducts leading to a common manifold and control of the rate of cooling is effected by increasing or reducing the rate of airflow through the manifold.

Preferably the temperature measured by each sensor is continuously monitored and is used to send a control signal to the relevant heat exchanger duct or manifold to correct any shift in temperature.

In another aspect the invention provides an electrolytic pot for smelting aluminium, comprising:
a carbon lined pot having a metal shell and containing a plurality of anodes and cathodes and in use capable of containing an electrolyte of alumina and additives which is converted by electrolysis to molten aluminium,
wherein the pot has:
a plurality of temperature sensors situated on or adjacent the metal shell,
a plurality of heat exchangers on or adjacent the metal shell, with each heat exchanger located in proximity to one of the temperature sensors and capable of providing localised cooling,
at least a portion of the exterior of each heat exchanger is insulated to reduce heat loss therefrom,
means for monitoring the temperature sensors and means for controlling the localised external cooling.

Preferably at least some of the heat exchangers have forced air cooling ducts so that control of the airflow controls the amount of heat extracted from that locality of the pot.

Preferably the heat exchangers are air suction heat exchangers allowing air to be drawn through the ducts.

Preferably the heat exchangers have a plurality of ducts leading to a common manifold and control of the rate of cooling is effected by increasing or reducing the rate of airflow through the ducts and/or the manifold.

Preferably each temperature sensor is a thermocouple.

Preferably each thermocouple is secured to the exterior of the shell with a quick release mechanism that enables the thermocouple to be installed and replaced rapidly and without difficulty by an Operator.

In a further aspect the invention provides a potline containing a plurality of electrolytic pots for smelting aluminium, each pot as set forth in the statements above.

In another aspect the invention provides a data network for monitoring a potline as described in the preceding paragraph, wherein each sensor provides an output to a computer monitoring system with provided software which stores, displays, and alarms temperature for each pot sensor to detect heating or cooling trends or temperatures outside pre-set parameters.

### BRIEF DESCRIPTION

The invention will now be described, by way of example only, with reference to the accompanying drawings:

FIGS. 1 to 7 inclusive are by way of background to illustrate the layout of a pot and the problems which can arise during aluminium smelting.

FIG. 1 is a schematic showing the interior of a pot and the various layers within a conventional pot.

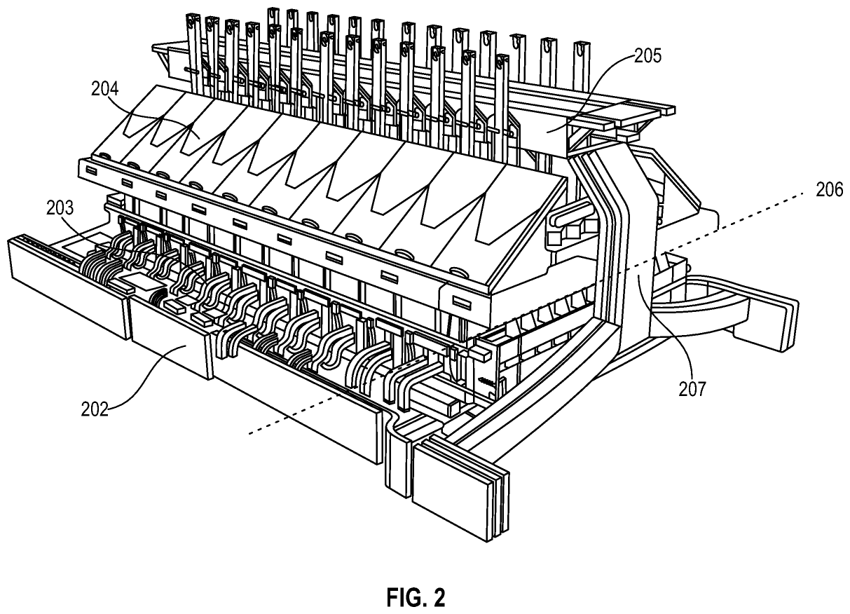

FIG. 2 is an exterior view of a typical pot with its hoods to contain the gases expelled during aluminium smelting.

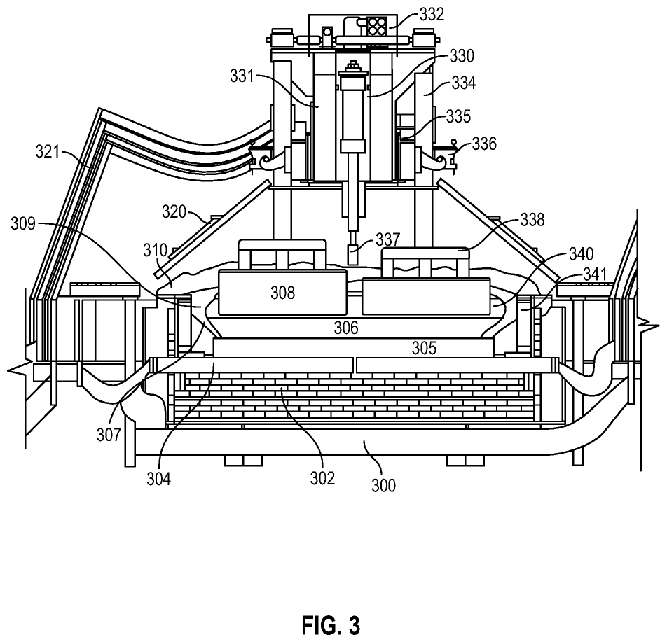

FIG. 3 shows a more detailed cell schematic, with the carbon anodes being raised or lowered relative to the cell.

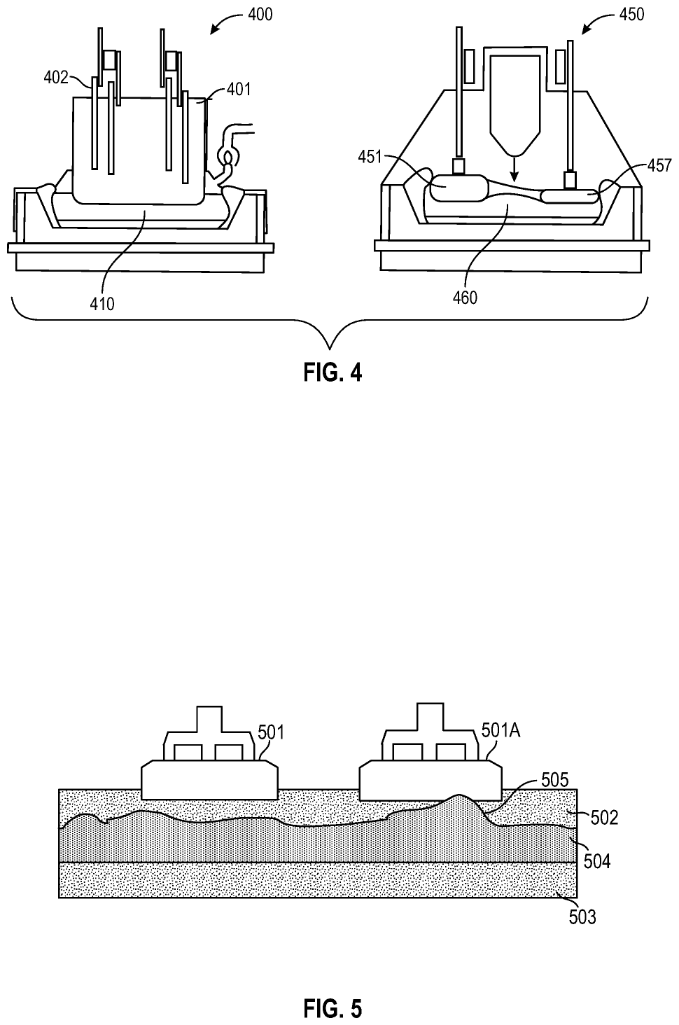

FIG. 4 shows different anode types for use in an aluminium smelter.

FIG. 5 shows the effect of magnetic forces generated in the molten aluminium pool and the problems that can arise.

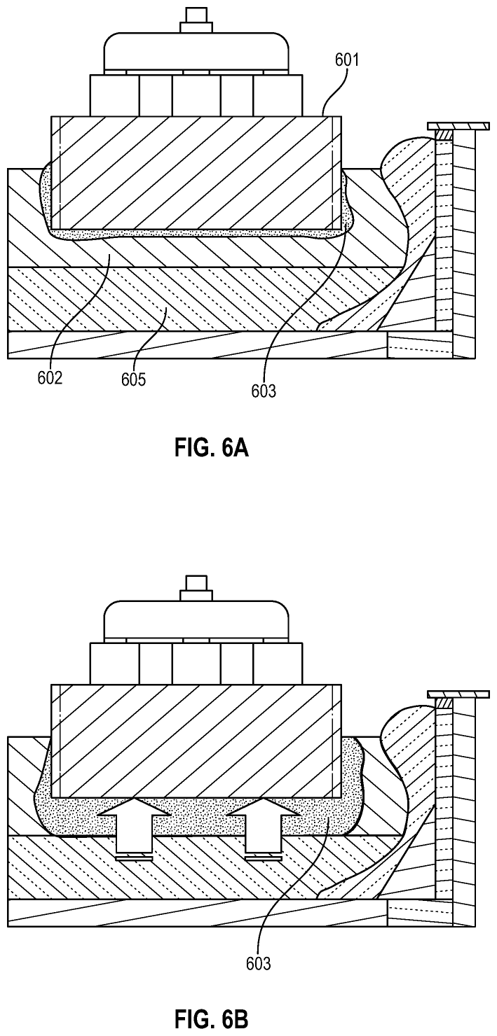

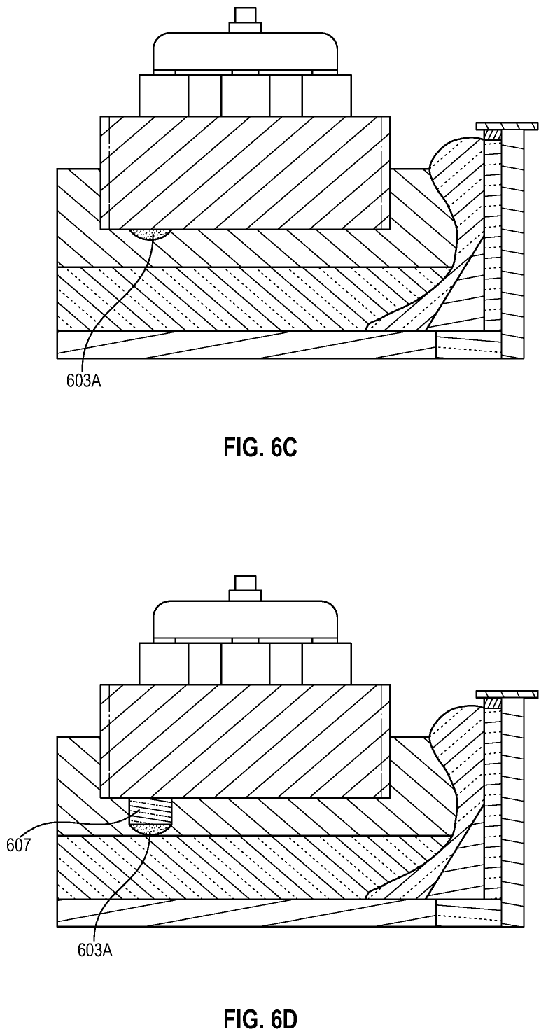

FIG. 6 is made up of FIGS. 6A, 6B, 6C and 6D showing the build-up of a spike over time and the resulting short circuit.

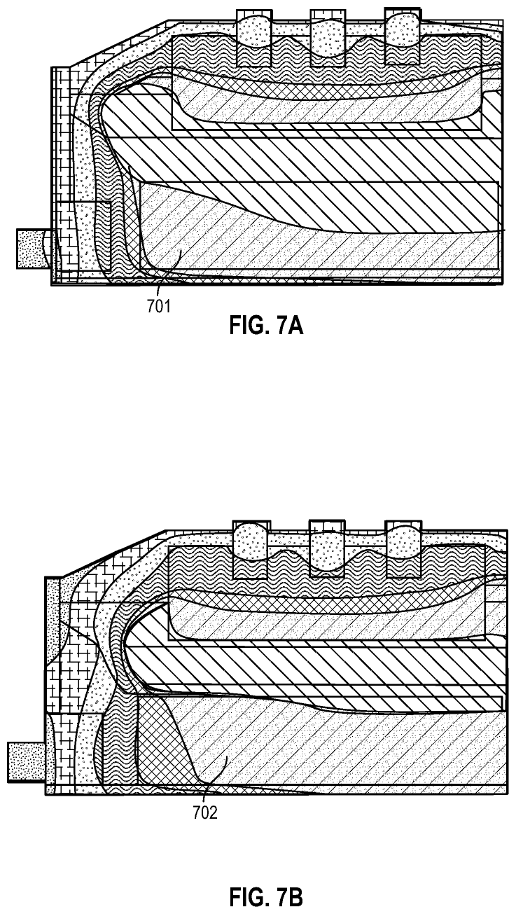

FIG. 7A shows a pot with a thin ledge.

FIG. 7B shows a pot with a thick ledge.

FIGS. 8 to 15 illustrate the improvements made by this invention.

FIG. 8 is an overview showing two enclosed pots side-by-side equipped with suction heat exchangers, and temperature sensors. The individual heat exchangers being connected to a manifold which in turn is connected to a master manifold and to one or more suction fans.

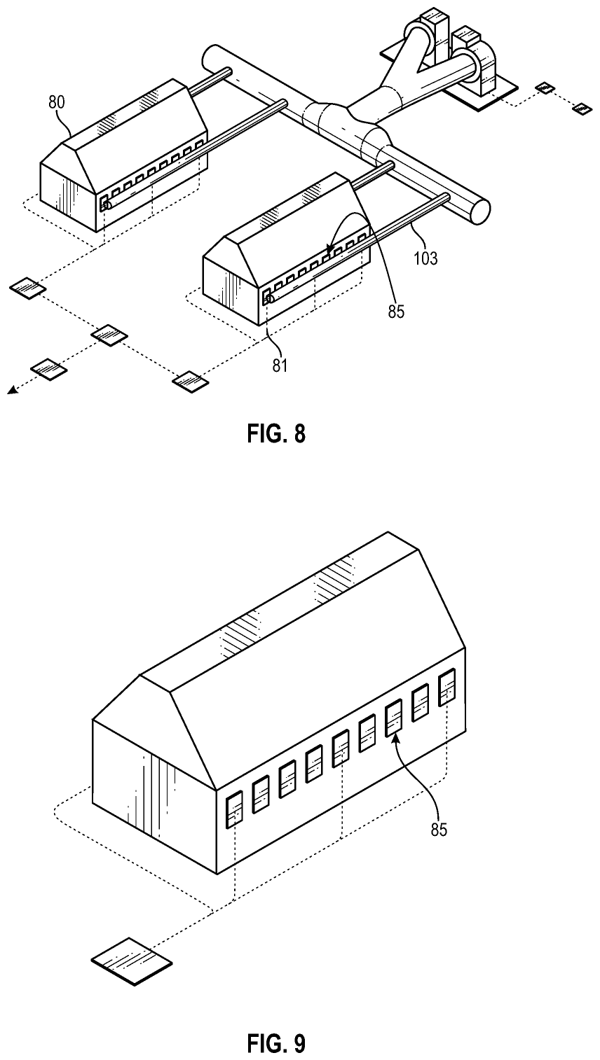

FIG. 9 shows a preferred placement of the temperature sensors along the length of a pot. Each temperature sensor is connected to a bus which is connected to at least one computer with provided software capable of monitoring the temperature sensors.

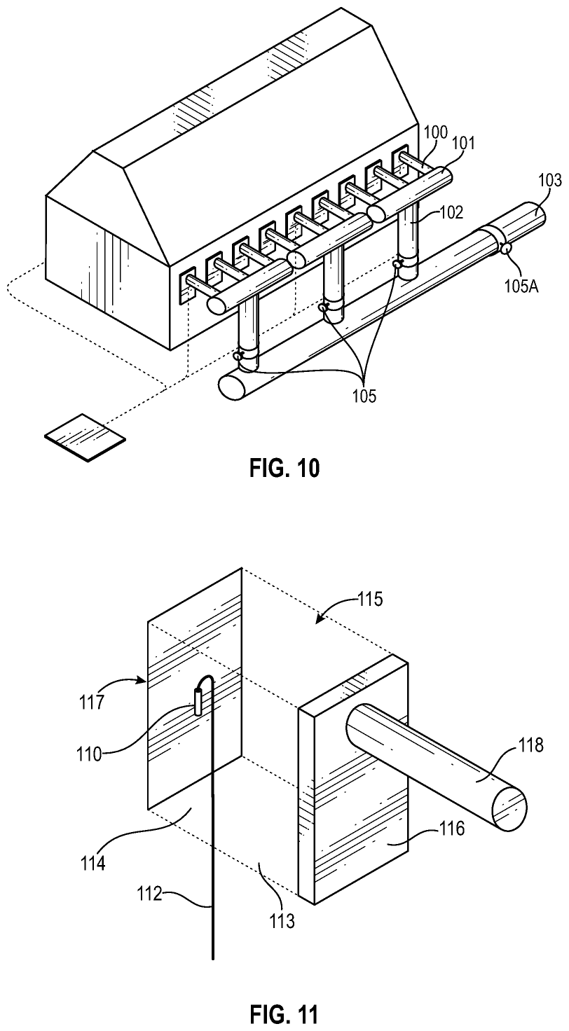

FIG. 10 shows the pot of FIG. 9 but this time overlaid with ducting connecting groups of the individual heat exchangers with a sub manifold, and each sub manifold being connected to a master manifold.

FIG. 11 is a schematic view of the placement of the temperature sensor on the exterior surface of the metal shell of the pot, effectively sandwiched between the exterior of the metal shell and the associated heat exchanger.

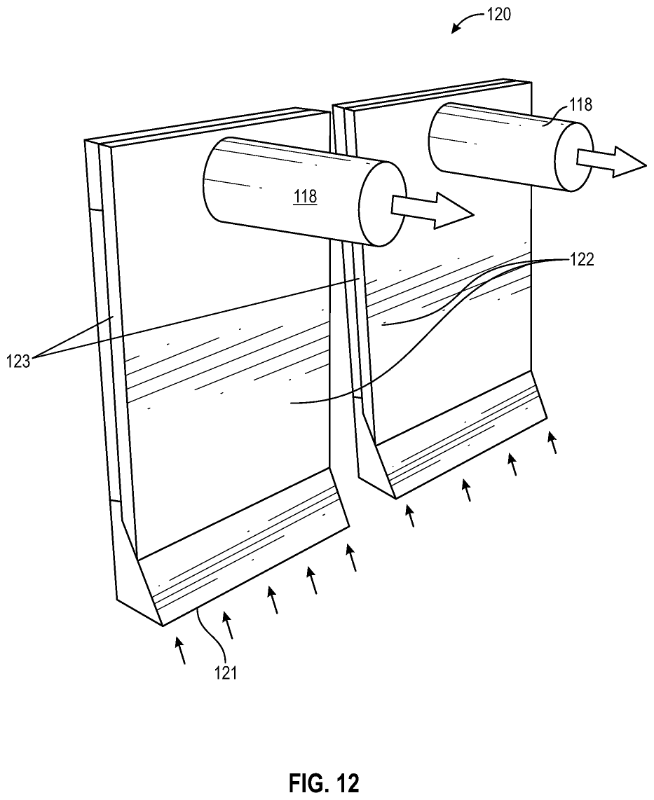

FIG. 12 is a schematic view of the individual heat exchangers, drawing in ambient air from the bottom, through the heat exchanger and out through the ducting leading to the sub manifold.

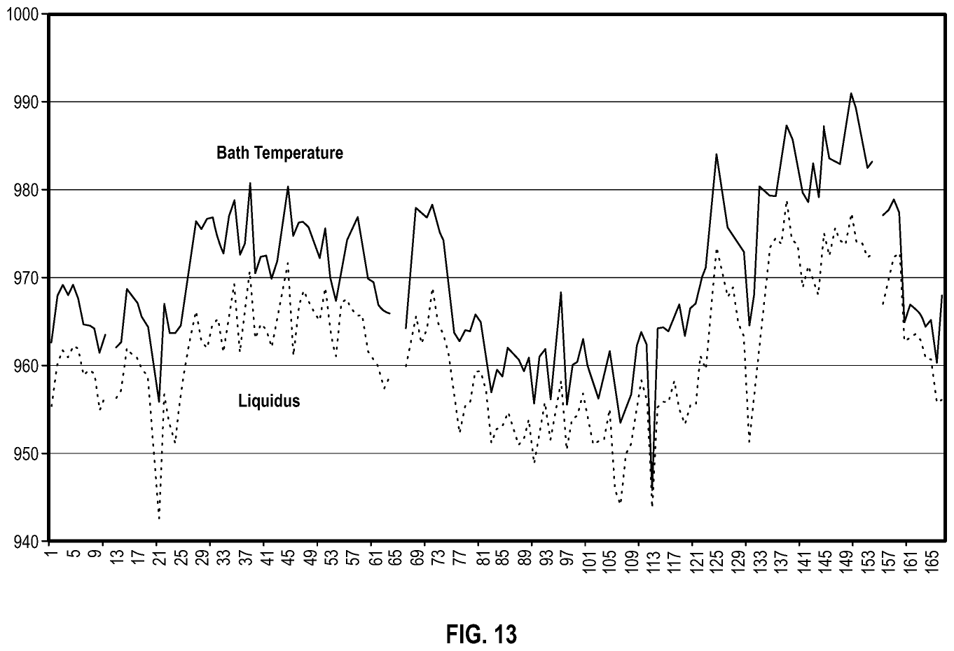

FIG. 13 is a Graph of bath temperature and liquidus temperature.

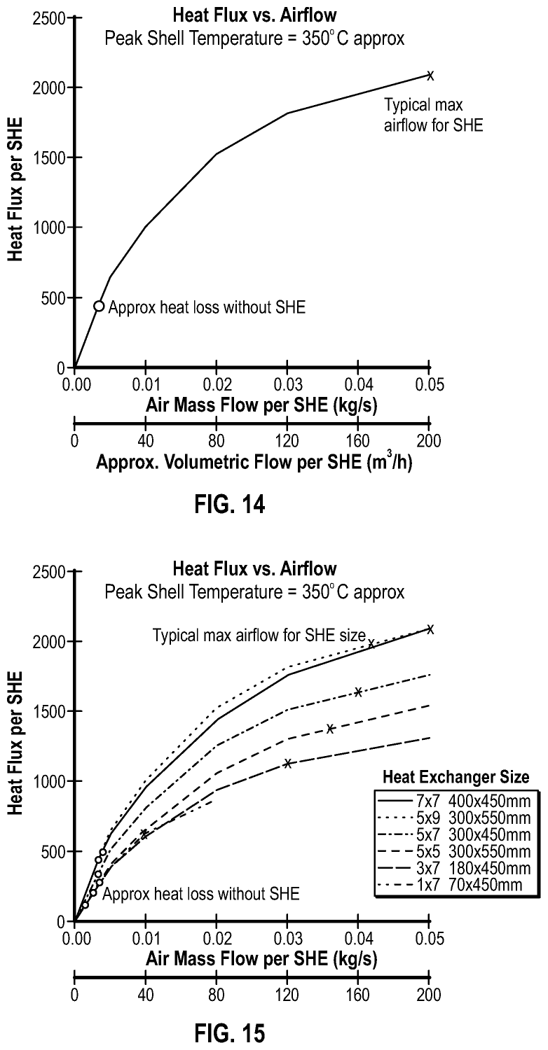

FIG. 14 shows a graph of heat flux v air flow.

FIG. 15 shows tests of different sizes of heat exchangers and their relative cooling rates.

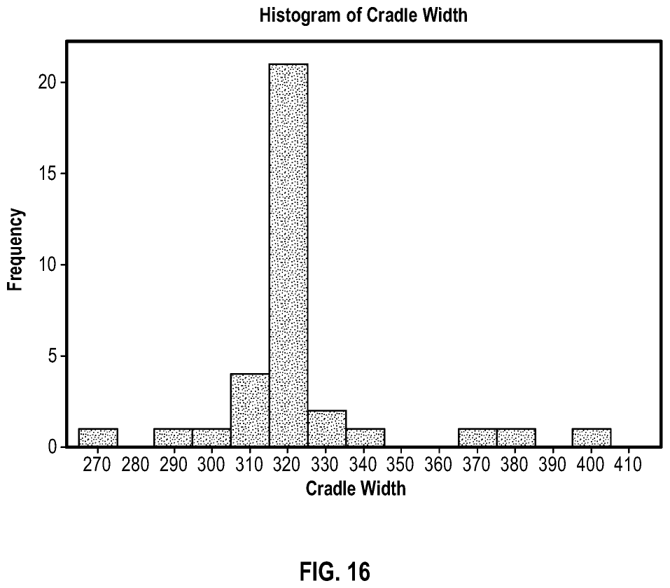

FIG. 16 shows a histogram of measured variation of shell cradle spacing (the space in which heat exchangers need to fit).

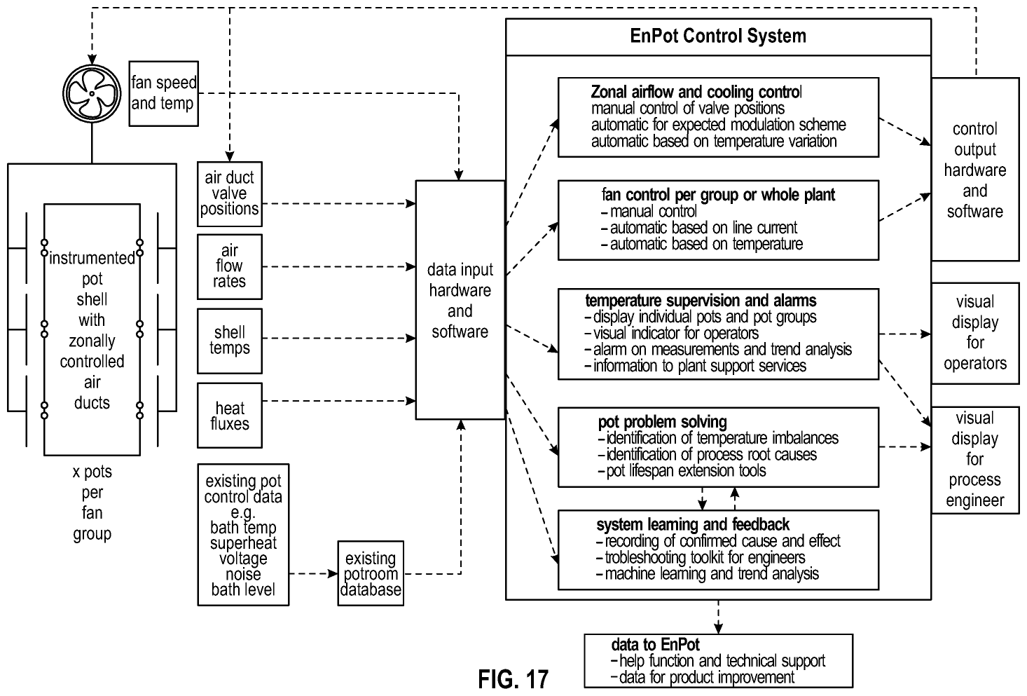

FIG. 17 shows a chart of data flows and control processes.

### DESCRIPTION OF THE PREFERRED EMBODIMENT(S)

The following description will describe the invention in relation to preferred embodiments of the invention, namely an aluminium smelting method & apparatus The invention is in no way limited to these preferred embodiments as they are purely to exemplify the use and application of the invention only and that possible variations and modifications would be readily apparent without departing from the scope of the invention. Moreover, in the description and examples below it is anticipated that the computer hardware itself will be the only component of the system which is not supplied as part of the heat exchanger/duct and valving/sensing monitoring and control system. All other components and control software are expected to be supplied as a package to put the invention into practice.

### Overview

FIG. 1 provides a schematic of an electrolytic cell for smelting aluminium. Each cell or pot is essentially a large metal tank with removable gas collection hoods over the top with a structure including a mechanism to feed alumina into the pot. Because of the temperatures involved and the need for an electric circuit within the pot, the steel shell is lined with carbon and where appropriate with a refractory material to protect the steel from the high temperatures within the pot. The gas collection hood enables the removal and recovery of the noxious gases generated by the process. The gases involved include carbon dioxide from the oxidation of the carbon anodes and fluorides from the electrolyte.

The carbon anodes can move up and down within the cell, and so can the breaker which is designed to break through the frozen crust of the electrolyte, to allow fresh alumina to be added to the cell. The components of the cell are as follows, starting with the bottom of the figure in moving clockwise around the exterior.
1001—Steel shell
1000—cathode current collector bars
1010—brick lining
1020—molten aluminium
1030—carbon anode
1040—crust of frozen cryolite bath and alumina
1060—fume extraction
1070—gases to fluoride recovery system
1080—alumina hopper
1090—removable gas collection hoods
1100—crust breaker and alumina feeder
1110—molten bath
1120—sidewall refractory lining
1130—carbon cathode.

Electrical current passes between the carbon anode and carbon cathode, resulting in the electrolysis of the dissolved alumina, which in turn allows molten aluminium to settle in a liquid pool at the bottom of the pot, which sets or rests on the lower carbon cathode.

FIG. 2 shows the features of a typical industrial cell viewed from the exterior and shows the placement of the Hoods—204, flexible connectors—203 and bus work—202 (these need to be large to allow for the very high current). The hoods (204) cover the top of the cell and the anode beam—205 is situated substantially central with the cell and the risers—207. This diagram also shows that the bulk of the cell is situated below the floor level 206 allowing the operators, maintenance workers and engineers to supervise the operation of each pot from above.

FIG. 3 shows a more detailed conventional larger cell with the different components. Here the bus bar is situated both beside and below the confines of the pot. The components) are:
Busbar—300
thermal insulation—302
collector bar—304
bottom block—305
aluminium pad—306
side ledge—307
carbon anode—308
top crust—309
alumina cover—310
hooding—320
risers—321
alumina hopper 330
pot gas exhaust—331
dense phase system—332
Air cylinder—333
aluminium rod—334
anode beam—335
anode clamp—336
crust breaker—337
yoke—338
cryolite electrolyte—340
steel shell—341.

FIG. 4 shows the difference between a Soderberg Anode 400 and a Pre-Baked Anode system 450. These are pre-existing components shown for background explanation only.

The Soderberg anode is shown at 401 supported by anode studs 402. The prebaked anodes are 451 and 452 (the latter one having been worn away). Both anodes are in contact with molten flux 410 and 460.

FIGS. 5 and 6 shows some of the problems that can occur in a large-scale pot. In FIG. 5 the schematics show the “anode-cathode distance” represented by the letters “ACD”. The cathode 503 is covered by the molten aluminium pool 504. FIG. 5 shows the anodes 501 and 501A entering the electrolyte bath 502, but because of magnetic forces generated in the aluminium pool by the large magnetic fields combined with disturbed currents flowing in the metal pad this combination of forces causes metal heave and create waves 505 in the metal pad. This can result in part of the aluminium Pool at 505 touching an anode 501A, and in this occurrence shown on the right-hand side of FIG. 5 the cell will short-circuit at that point. This instability in larger pots can place a practical limit on the anode cathode distance.

FIGS. 6A-6D show a sequence of events involving a spike formation. This can cause a short-circuit, this time resulting from an anode spike. In FIG. 6A, a new anode has been inserted into the bath, and FIG. 6A shows the bath 602 freezing on the bottom of a new anode at 603 at 15 minutes after insertion into the bath.

FIG. 6B shows the same anode but at 100 minutes after insertion, with the freeze 603 growing until it reaches the metal pad, and then the heat from the metal pad begins to melt the frozen electrolyte 603.

FIG. 6C shows the same anode at 700 minutes after insertion, with most of the freeze 603 having melted but a small section 603A remains.

Finally FIG. 6D shows the same anode at somewhere between three and six days (4320-8640 minutes) after insertion. Much of the anode 601 has worn down except for where it is coated in the freeze 603A. As the anode is lowered further into the electrolyte bath the resulting spike 607 then hits the pad and a short-circuit results.

Sometimes loose pieces of carbon can also weld to anodes forming spikes. Spikes cause significantly increased local heat generation in the anode, as electrical current will be preferentially carried though the anode with a spike due to the short anode-cathode distance and least electrical resistance at this point.

If the bath, or localise portions of it in the pot, runs too hot as shown in FIG. 7A, then there will be a high superheat, resulting in a thin ledge 701 or no ledge at all. Without the frozen ledge protecting the shell, there will be damage to the refractory wall and the shell will run red hot and may cause the pot to be shut down, and repaired. This may also cause a catastrophic failure involving a tap out of metal and bath leaking from the pot and damaging other equipment and causing a major safety hazard.

On the other hand, if the bath is too cold as a result of low generation or high heat losses then there will be low superheat as shown in FIG. 7B and the development of a thick protective ledge 702. But this can also result in poor feeding of the alumina, with the build-up of sludge, anode effects, electrical instability and low current efficiency.

All of these are known effects which occur when operating an aluminium smelter.

The improvements will be described with reference to FIG. 8 onwards.

The essence of the preferred solution to the problem is having continuous temperature measurement to enable early detection of internal cell problems, combined with the ability to act on those temperatures quickly by locally adjusting heat transfer through the sidewall in order to maintain ledge protection adjacent to the spike, or other problem in the cell. In this case the heat transfer is adjusted using shell heat exchanger units and varying the air suction through them. This is localised by connecting the heat exchangers to several ducting groups around the cell, such that each group can be independently controlled via valves.

An example of this advantage would be the detection of an ‘anode spike’ inside the cell, caused by mechanical issues with a new anode or the physical process of installing the new anode. When a spike occurs, there is a huge local increase in current flow and heat generation. This local heating can cause rapid local melting of the protective ledge and hence damage to the adjacent refractory material. Previously, a spike may not be detected for 1-2 days until the cell liquid temperature measurement is done, at least as much as a full day later, by which time the whole cell internal temperature has risen to a dangerous level regarding refractory damage.

In the case of this invention, shell thermocouples would detect the rapid increase in shell temperature above the normal level much sooner i.e., within minutes or an hour depending how close the thermocouple was to the problem location. This would enable the problem anode to be removed as soon as possible, and the spike fixed, and in the meantime the shell cooling could be increased immediately to reverse any melting of the protective ledge and prevent refractory damage.

Beyond the immediate short-term issues of anode spikes for example, elevated shell temperatures can also occur due to accumulated damage over time, particular in the regions where cell operations such as metal tapping occur regularly (every day or two) or where liquid aluminium velocity is known to be high. The regular disturbance of the cell in this area can cause irregular freezing or melting of the protective ledge, or mechanical intrusions can cause wear and damage directly to the underlying carbon cathode, providing an escape route for liquid metal tap outs and cell failure.

In many cases, this accumulated damage would not be identified until the cell was near failure (measured by high silicon and iron content in the liquid metal) or until the cell physically failed, causing a safety risk and high additional costs. With the advantage of shell thermocouples and a monitoring and control system for them combined with controllable shell cooling, the increase in shell temperature over time could be tracked and predicted when a failure was likely to occur, or some risk of failure could be permanently reduced by applying additional cooling to regions where this damage happens.

The large number of cells present at a smelter, which can be several hundred or more means that any particular cell has only very limited personal attention paid to it by process engineers. Most cells running within normal parameters have good efficiency, but cells running extremely hot or cold have very low efficiency, dragging down the overall process efficiency of the potline. Finding and correcting problem cells as described herein allows the smelter to maintain good efficiency and production for the whole plant.

The invention has great applicability to detecting and correcting problem cells because every cell can now have continuous monitoring of temperature and temperature changes. While not directly measuring the internal liquid temperature, the external shell temperature and changes in this temperature can also infer changes in the internal temperature, at a much smaller time lag and with greater specificity than waiting until daily or two-daily liquid temperature measurements are taken.

Furthermore, the invention can help identify cells which are operating in suboptimal ways despite having a normal liquid temperature measurement. A large imbalance in temperature distribution around the cell, as indicated by shell thermocouples, can indicate a problem with balance of current distribution through the cell anodes or cathodes i.e., cold areas which are not carrying enough current, and hot areas which are carrying too much. These current distribution problems may be detected and corrected via mechanical changes such as anode setting problems, or the root cause may be due to cell thermal designs or particular cell locations relative to prevailing weather or draughts etc. In this case, thermal balances can be fixed by forced changes in heat transfer using the shell heat exchange units and varying airflow balances.

In this way, small imbalances in cell performance can be corrected via measurements which cannot be practically done at a smelter other than by permanently installed and monitored thermocouples. The measurements needed to find these imbalances are not practical to undertake on a regular basis due to the large number of cells, and hence this invention using permanent monitoring is the best way to find and correct them.

Rapidly finding and correcting cells with major problems is the first key advantage of the invention and finding and correcting potentially a larger number of cells with smaller problems such as temperature imbalances is the second key advantage. In this way plant engineers can achieve the best overall increase in plant efficiency and productivity.

### Example 1

The invention involves the use of ‘shell heat exchangers’ mounted permanently to the side of the smelting cell/pot, on any group of cells or every cell in the smelter. These provide cooling to the sides of the shell via an induced suction draft, where every heat exchanger is connected via a ducting network to a suction fan installed outside of the pot room. By using suction airflow the suction fans can be located remotely from the pot room and can be more easily controlled/maintained.

Furthermore, the heat exchangers include an insulated backing, so that a minimal airflow is required to maintain the pre-existing heat transfer from the shell sidewalls. When the airflow is increased, there is a significant increase in shell cooling, and when the airflow is decreased below the base value towards zero flow, the insulation ability reduces heat transfer to a very low level (radiation and convection at much less than natural levels) and thus can warm cooler parts of the shell and/or enabling operation of the cell at lower line current and heat generation while maintaining the correct heat balance.

FIG. 8 is a schematic showing two pots having both a series of temperature sensors (not visible as they are under some of the heat exchangers) and a series of heat exchangers 85 along the length of each side of each pot. The preferred heat exchangers are airflow heat exchangers.

As shown in FIG. 8 and more explicitly in FIGS. 9 and 10, each side of a pot has provision for a plurality of temperature sensors, in this case three temperature sensors attached to the exterior of the metal shell of the pot and sandwiched between the exterior of the metal shell and the adjoining heat exchanger 85.

Preferably each temperature sensor is a thermocouple 110 which is mounted on the side wall of the metal shell as represented in FIG. 11, and for example this could be a metal tube 110A welded to the side of the metal shell in which the thermocouple 110 is inserted from above with its wires 112 extending downwardly towards a common bus as shown in FIG. 9, which in turn is connected to a computer system for monitoring the temperature detected by each thermocouple. Preferably the bottom of the tube 110 is closed to airflow such that the thermocouple is not affected by the suction draught.

FIG. 10 shows the placement of three heat exchangers 85 to each individual thermocouple 110, with each group of three heat exchangers 85 being connected by ducts 100 to a sub manifold 101 (best seen in FIG. 10) and each sub manifold 101 is connected by further ducting 102 to a master manifold 103 again as shown in FIG. 10.

The schematic of FIG. 11 shows that each heat exchanger can be represented as a box (preferably a backless box) attached to the exterior of the metal shell 117 with the bottom of the box 113 being open to ambient air, and the sides 114 and the top 115 enclosed, with the outermost side 116 being visible in FIGS. 9, 10 and 11, with a duct 118 extending through outermost side wall.

Note that this exterior sidewall 116 is insulated to minimise uncontrolled heat loss, so that if the airflow is reduced or turned off, heat flow through the metal shell to the exterior will mostly be contained inside the heat exchanger. Thus, by reducing the airflow through the heat exchanger, the temperature of the bath can be allowed to increase, and conversely by increasing the airflow through the heat exchanger the metal shell can be cooled thereby cooling the contents of the bath. The combination of the temperature sensors associated with one or more insulated heat exchangers, and by frequently, and preferably continuously, monitoring the temperature detected by the temperature sensor, enables the computer system to control the airflow through selective exchangers to control the bath temperature and to improve the efficiency of the pot.

The heat exchangers are designed to cover as much of the sidewall of the shell as possible, but there are two issues a) the steel cradles around the shell which we have to fit between, including additional cooling fins, and b) variation in the widths/positions of these items, such that heat exchangers may need to be a bit skinnier than is desirable to make sure they all fit.

FIG. 16 shows a histogram of measured variation of shell cradle spacing (the space in which heat exchangers need to fit) at one smelter to illustrate the problem of fitting pre-made heat exchangers to pots in situ. The histogram is based on the measured variation in cradle spacing on two shells at one smelter (a total of 34 measurements).

Note this means that the optimal design of a 320 mm wide exchanger will not fit in some spaces and will result in uncovered area in some other spaces. A practical solution is to design for heat exchangers with a width of 300 mm with a few units available at a width of 270 mm to fit in the skinny spots.

There is a fixed initial design size of cradle spacing, but over many years it can shift as pots are reconditioned, and some structural steel is refitted manually (welded) or using a simple template which isn't accurate. Or some smelter design pots sit on a floating cradle structure which isn't always properly aligned with the steel pots.

Ideally every single pot would be measured at a smelter before construction/installation, but this is not practically feasible while the pots are operating. Access is probably possible in most locations, but the time cost would be prohibitive. Instead, we propose to measure x number of pots available during offline reconditioning and make the units small enough they should fit almost all locations within that smelter.

The typical width of each heat exchanger is anywhere between 200-400 mm usually, and the depth around 30 mm—this is 10 mm of airspace and 20 mm of insulation.

This insulation space could be stagnant air although preferably it is about 20 mm of ceramic fibre (Kaowool brand) insulation. We have found that 20 mm provides sufficient insulation for our operating conditions and is cost effective. There would be diminishing returns beyond 20 mm.

The size of the heat exchangers will depend on the layout of the structural shell around the pot. In some cell designs the structural steel takes up a lot of space and hence allows for less heat exchanger coverage. Preferably there is also a glass fibre sealing rope around the perimeter of each exchanger (to minimise air leakage) which slightly reduces some of the airflow cross-section of the suction air heat exchanger.

We prefer that each heat exchanger does not have a fully enclosed back wall but instead the heat exchanger has an open face which is clamped to the pot shell. Preferably the heat exchangers are designed to be easily mounted and removed using clamps.

In one preferred installation a combination bracket/clamp is screwed into the support steel, and a spring-loaded screw on the clamp is tightened to push the exchanger onto the shell, using a spreader mechanism to hold it evenly. The clamp design is customised to fit the existing pot support steel structure and cradles. The small thermocouple mounting tubes 110A are preferably closed at the bottom of the mounting tube. They may be spot welded to the shell or attached also via a spring clamp.

The greatest coverage of the pot shell area with heat exchangers is desired in all cases. However, there are physical and practical installation limitations which may limit coverage. The remainder of the shell—gaps around exchangers, and the surfaces of the support steel is not practical to insulate or to add more cooling to.

Preferably the heat exchangers cover the relevant portion of the sidewall where the liquid is contained, and the largest portion of the heat is lost. In some very recent smelter developments involving highly conductive cathode assemblies it may be desirable to insulate the lower sidewall as well during off-load periods.

In other pot designs is not desirable to extend lower because cooling adjacent to the carbon cathode may cause freezing of material over the cathode and poor current distribution in it, and conversely, insulating that part may allow some leakage of liquid material from the cell normally protected by frozen electrolyte.

The heat exchanger stretches most of the way up the sidewall, and above it is largely the frozen top part of the cell cover material rather than liquid contents.

The coverage height of the heat exchangers must suit the particular cell design in use, and this is a key consideration for the inventors in their heat exchanger design and fitment for each smelter.

Preferably for cooling of the walls during an increase in the power input and production rate, the heat exchangers cover the area where the heat transfer is highest, most able to be controlled, and most critical to the performance of the pot.

However, for some pot designs today, the conductivity of the cathode and its collector bars can be much higher than previously-being graphitised carbon and copper bars respectively. In this case the rate of cooling of the cathode in the event of amperage reduction or potline off-load is much higher. The use of heat exchangers for these designs can be extended further down to the level of the cathode to prevent excessive heat loss and freezing inside the pot when the heat exchangers are in insulating mode.

FIG. 12 shows a typical air suction heat exchanger 120 used in this invention with a wider air inlet 121 and relatively thin structure 123 leading to an outlet duct. The outer portions marked 122 are insulated.

Preferably the heat exchangers are suction air heat exchangers with the air being drawn in from the bottom of each heat exchanger box and sucked out through the ducts 118 as shown in FIG. 12. Turning back now to FIG. 8 it will be noted that the manifolds lead from each side of each pot to a much larger manifold which in turn is connected to one or more suction fans capable of drawing carefully controlled volumes of air into the selected heat exchangers and out via the fan or fans.

Suction heat exchangers are preferred, as the operating fan motors can be kept well away from the vicinity of the very hot pots, remembering that the pots operate at an internal temperature of about 950° C. This also allows the fans and fan motors to be maintained and their AC power supply protected against failure during service, so that a reliable, continuous flow of air is maintained through the heat exchanger/ducting network.

By controlling the airflow through selected heat exchangers in response to the temperatures detected by an adjacent temperature sensor, it is possible to maintain the sidewall ledge at all locations in the pot, even with fluctuating power input. The design of the suction heat exchangers is such that they can operate in either insulating or cooling modes with the airflow set to a low/off position, or at a higher/on position, respectively. Less potline power can be used when it is expensive (for example using lower amperage), and the temperature of the pots can still be maintained. Therefore, this invention allows the aluminium smelter to take more power when it is cheap, in order to increase production, and enables the most efficient temperatures and heat balance to be maintained in the pot.

FIG. 13 shows the correspondence between the bath temperature and the liquidus temperature.

FIG. 14 shows a graph of heat flux v air flow.

FIG. 15 shows tests of different sizes of heat exchangers and their relative cooling rates.

### Example 2

Turning to FIGS. 8 and 10, a preferred method of controlling heat extraction via the heat exchangers is to use valves 105 in conjunction with the suction heat exchangers. Such valves are best situated between each bank of heat exchangers and the master manifold. FIG. 10 also shows a valve 105A on the master manifold. Although it is possible to have one valve per heat exchanger, we recommend one valve per group of heat exchangers. Such a valve can be a manually or electrically controlled flow restriction valve such as a butterfly valve.

Any flow control valve can be used, though we prefer a butterfly valve which can be rapidly opened or closed.

In an initial, low or medium scale installation it is possible to only install manually controlled valves, as adjusting these valves (airflow balancing around a pot) is not likely needed often beyond the initial setup of the system-they may be used more as a calibration adjustment or to fix occasional problems on demand.

The airflow to the whole pot/group can also be controlled via a variable speed drive on the fan. Preferably for large potlines some or all valves will be controlled automatically and in response to shell temperature signals. In the final implementation of the valving system it is desirable for them all to be automated in order for optimal control of the pot/potline heat balance and associated pot performance to be reached.

Since the air is being sucked through each heat exchanger by the fan or fans connected to the main manifold for the plant, the localised restriction of airflow through one group of heat exchangers will not impede the airflow through the other heat exchangers.

In this example, the fans (preferably two or more) allow one fan to work constantly with the other as a backup or load balancer if extra suction is needed to control the temperature of a plurality of pots at the same time. That way suction is always available if one sensor detects an overheating problem, so that airflow through the adjacent heat exchangers can rapidly be increased by opening the relevant valve.

### Example 3

FIGS. 8 and 9 show part of a data network for monitoring a potline (made up of a plurality of pots, only two of which are shown in FIG. 8). Each sensor provides an output signal to a data bus which in turn is connected to a computer monitoring system. The computer system has means for storing temperature records for each pot sensor to detect heating or cooling trends or temperatures outside preset parameters. See also FIG. 17 described in detail below.

Thermocouples by nature allow for continuous measurements, whilst it is a function of the control system how often they are recorded or reported. A very typical situation would be 30 s intervals, but this data may be stored for only a few days, whereas daily averages may be stored permanently. Our preferred control system operates on a similar frequency where the data would be examined at say 30 s intervals, (about 100 to 120 times per hour) and changes made accordingly.

In contrast any measurements made manually in prior, conventional potlines (such as by using manually inserted thermocouple probes, infra-red measurements, or by chemical analysis etc) can only be done very infrequently e.g., daily for problem pots, and monthly or never for the average pot.

The thermocouples are connected to a data network, such that all temperatures are continuously available to be examined, and continuously monitored by a computer monitoring system. This monitoring would enable:
Immediate detection of temperatures which are too high or low compared to the normal temperature distribution, such as may be caused by internal process excursions causing changes in the frozen ledge thickness (freezing or melting) or refractory damage.
Detection of heating or cooling trends on any thermocouples indicating changes in the internal temperature or heat transfer. These may be detected and acted upon before breaching normal ranges and before causing refractory damage or other process issues.
Detection of common temperature patterns around multiple cells, such as cell designs or changes in operating parameters which cause regular hot or cold locations on a number of cells.
Detection of changes in temperature distributions due to external ambient condition changes
The heat transfer from every cell can be controlled by varying airflow to the heat exchangers based on shell temperatures, such that external shell temperature is maintained consistently across a wide range of changing input or external conditions, such as changes in input line current.
Control of shell temperature may have a significant advantage regarding life span of the cells, as changes in heat generation and heat balance can be managed to avoid changes in thermal expansion of the shell, which can cause accumulated refractory damage over time.
Prevention of sidewall corrosion (attack by molten electrolyte) through better temperature management will also extend pot life span considerably since sidewall failure is the cause of 20-50% of all pot failures, depending on technology.

The third key feature of the invention is the design of the ducting system such that heat exchanger airflows can be controlled in set groups. A typical design may be based on the length or size of the cell, for example a cell could have three airflow control manifold sections per side, such that airflow and heat transfer could be controlled in a central group separately to two groups at either end of the cell. Ducting and sizing of heat transfer groups may also be based on particular design needs of the pot, such as one modern design where the central 5 anode positions have a higher heat transfer rate and need more cooling. This would be optimised by a single ducting manifold connected to these shell positions to be controlled separately.

Any number of manifold sections around the cell could be used, based on practical engineering considerations such as the space available for ducting. This could involve any number of heat exchanger units being controlled in separate groups, from as few as one air flow control group per cell, up to every heat exchanger unit being controlled individually. Typically there may be 8-12 heat exchangers per bank/manifold. In most cases the size of the pot will require 24-40 heat exchangers down the side of each pot, compared to the simplified drawings which explain the principle but not the actual number of heat exchangers used in practice.

The airflow control groups would be controlled by a valve, such that opening the valve would give more airflow to the controlled heat exchangers and increase the heat transfer and cooling in that section. Closing the valve would reduce the airflow to that group and reduce the heat transfer and heat loss via the insulating nature of the heat exchangers. These control changes could be done by manually changing valves, or the valves could be automated or motorised and controlled via a shell temperature control system.

This airflow control system has the following major advantages:
Temperature issues identified by the installed thermocouples can be acted upon immediately by changing airflow valves, either manually or via automatic control
Temperature issues are often localised to some parts of the shell only, and the design of airflow manifolds can be leveraged to only apply further cooling or insulation to the required area.
Cooling increases can be made permanently to parts of the shell which have accrued refractory damage. This may commonly occur in the area of the shell near where operational procedures occur frequently (such as liquid metal tapping) or where liquid metal velocities are high, causing damage over time, or damage may have occurred at any area of the shell due to a critical process excursion.
Cooling changes including increased cooling or increased insulation can be made permanently to areas of the shell based on design issues that may otherwise result in permanent hot or cold areas of the shell.
Cooling changes including increased cooling or increased insulation can be made permanently or temporarily to certain areas of the shell based on environmental factors such as ambient temperature changes, or prevailing wind direction which may affect certain cells or parts of cells only.
Changes to airflow and cooling can be made to any cell or part of a cell (manifold) at any time without additional equipment installation or labour other than changing valve positions.
Changes to airflow or cooling have no other effect on the process safety such as ambient noise or additional tripping hazards.

A fourth key feature of the invention are the other associated process control improvements that can be made as a benefit of the above features in combination.

These include:
Reduced heat stress on operators working on cells as much of the heat rising from the sides of the cell by natural convection and radiation is instead captured in the suction gas duct.
Some process abnormalities such as ‘spikes’ on newly-set anodes can be detected almost immediately via a sudden increase in a localised shell temperature. Without the thermocouples in this invention, detection of spikes may only happen serendipitously due to highly elevated liquid internal temperature measured once per day or two days. During this time there may be significant damage accrued due to frozen ledge melting and refractory corrosion.
Other process abnormalities can also result in high liquid temperatures such as elevated cell voltage used to overcome physical problems such as poor dissolution of alumina feed material. In this case frozen ledge melting can also cause refractory damage, however the invention can be used for additional shell cooling to prevent this melting and damage.

An additional feature of the invention is measurement of air suction temperatures adjacent to every cell, or in every airflow duct and prior to suction fan air entry. In this way changes in cell heat loss (via suction through the shell heat exchangers) can also be detected, and calculations made of cell heat balance including cell heat input (voltage and current) and heat losses. This may be a secondary way to detect temperature changes and heat balance problems, in the case that shell thermocouples are not available, either if they have not been installed, or have not yet been replaced over the service life of the cell.

FIG. 17—illustrates the control system which is part of the Heat Exchanger system herein disclosed.

The control system allows the benefits of the system to be achieved by the smelter. The chart of FIG. 17 shows the various inputs at the left of the chart with x pots per fan group and fan associated with the pots with monitors for fan speed and air temperature. The inputs from the sensors go to the data input hardware and software. Where our control system is set out—the software controlling various outputs including displaying information on monitors and various identified automated process providing feedback via the control output hardware and software to control the fan speed and hence control of the shell temperature adjacent the selected heat exchangers. Different monitors are used for the operators and the process engineer(s). Data can also be sent to our Technical Support to help functionality and technical support and provide data for further technical improvement.

The key components of the control system include:
Pot Instrumentation including but not limited to shell temperature thermocouples, shell heat fluxes, air control valve positions, duct air flow rates, duct air temperatures.
Pot group instrumentation also including fan speed (via a variable speed drive) and fan electrical signals including motor temperature, as well as air duct flow rates and air duct temperatures per fan grouping.
Data Capture input/output, where the data signals from pot instrumentation are collected, including other relevant signals from the existing pot control database, and sent via appropriate electrical hardware means to the control database software.
Visual display of all key information recorded by the control software with a number of different display options, including visualisation of all temperature values, abnormal values and temperature alarms, temperature trend displays for all pots or by grouping of all pots connected to each fan, overall plant temperature trends, plus a method of connection to the existing smelter database where detailed information around every pot including all measurements, and other process measurements for each pot can be found.
Control method for system operation, including different ways to control the suction fans for each pot group (manual or automated) and airflow balancing valves, either via manual recording of valve positions, or automated adjustment of valves with appropriate hardware installed.
Shell Temperature statistical analysis to identify pots and areas on pots which are exceeding (under or over) set limits, as well as statistical and trend analysis to identify pots and areas on pots which have abnormal trends (which may later exceed set limits based on statistical trend).
Alarming of abnormalities and trends in temperature and presentation of alarms to relevant operational staff—primarily pot operators, but also process engineers and superintendents to ensure safe and optimal running of the system. Data may also be sent to or visible to other plant departments such as pot reconstruction, where long term pot life effects can be studied, including cases of heat balance or design failures allowing pot shell corrosion by molten electrolyte, or leakages from the pot shell.
Escalation of certain severity, criticality or type of problem in shell temperature to the Process Engineer or the Superintendent of the Potline.
Problem solving tools to help operators or process engineers identify and troubleshoot issues with shell temperature excursions or abnormal heat balance, including known relationships to existing plant data that can affect heat balance such as voltage, metal and bath heights measurements, bath and superheat temperatures, chemical analyses including excess AlF3 in the bath, and Fe and Si measurements in the metal. Solutions may include direct action via adjustment of cooling or insulation ability of the heat exchangers and change of cooling/insulation balance around particular areas of the shell, as well as correction of root-cause problems identified by existing plant data.
Causal tree for each type of temperature signal (temperature excursions and abnormal heat balance) to aid the troubleshooting of the problem by plant operators and engineers. This tree builds up over time as users learn what different signals mean, including recording and display of previously identified and solved problems (confirmed cause and effects).
Output hardware and software to interface with existing plant control hardware and software systems
Output functions to control fan speed based on either manual selection within the control system, automatic control based on cell/potline amperage, or automatic control based on a measure of shell temperature around the pots connected to each fan, such as the average of all relevant thermocouples.
Output function to change the position of any airflow control valves in the ducting system, which have valve motors or actuators installed, to change heat transfer between different cells or zonally around any cell.
Data recording and transmission, particularly regarding overall performance metrics and problem cause and effect trees to improve overall product performance and future hardware and software development.

### Advantages

The key advantage of the system is the combination of enhanced measurement ability of shell temperature and the inference of internal cell issues stemming from this, coupled with the ability to affect changes to the heat loss on the exterior of the cell to combat internal cell problems. The system can prevent further damage from accruing by making permanent changes to cooling, or temporarily while internal problems are rectified.

Measurement of shell temperature without this system is arduous and not practically possible for any cells other than a few which have pre-identified issues that need to be monitored. Instead, this system provides continuous monitoring and identification of problems on all cells at any time, without additional labour or equipment usage, and with the ability to correct them.

Beyond the enhanced measurement and identification advantages, the shell heat exchanger system has significant advantages in ability to cool shells beyond the currently available technology using air lances, as the cooling ability is of a higher magnitude, and practically much easier as the equipment is already in place and the amount of cooling can be quickly adjusted at any time to provide insulating characteristics if necessary. A key advantage is that this cooling can be adjust zonally to correct for issues which are localised around a pot shell, and the zonal cooling can also be adjusted at any time.

The system also has the advantage of being able to reduce airflow and cooling to any area of the cell and hence can correct for heat balance/heat transfer irregularities around the cell such as hot or cold areas. Correcting these issues may result in an overall increase in efficiency and production due to improvements in the internal current distribution between anodes and cathodes, and in the stability of operation of the electrochemical process over time. Furthermore, the energy usage may be reduced if heat balance problems are corrected, as the frozen ledge around the perimeter of the cell is more even and stable, and cell voltage can be reduced as has been observed in one embodiment of the invention.

The design of the suction heat exchangers is such that they can operate in either insulating or cooling modes with the airflow set to a low/off position, or at a higher/on position, respectively. This has the advantage that less potline power can be used when it is expensive (for example using lower amperage), and the temperature of the pots can still be maintained. Therefore, this invention allows the aluminium smelter to take more power when it is cheap, in order to increase production, and enables the most efficient temperatures and heat balance to be maintained in the pot.

Another key commercial improvement is the prevention of early failure of cells due to refractory damage causing the tap out of liquid contents.

### Variations

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

As described, the temperature sensors are thermocouples mounted on the pot shell, under the heat exchanger units. These may be installed under any number of the exchangers, from as few as one per cell, or one per airflow control group (manifold), one per every exchanger, or some exchangers may even have a group of many thermocouples mounted underneath to investigate temperature variations. Whilst thermocouples are the preferred sensors—other temperature sensors can be used provided they can withstand the operating temperatures.

Alternatively, the pot temperature can be inferred by measuring the temperature. of the air in or leaving each heat exchanger or in every airflow duct and prior to suction fan air entry. In this way changes in cell heat loss (via suction through the shell heat exchangers) can also be detected, and calculations made of cell heat balance including cell heat input (voltage and current) and heat losses.

Whilst we have shown a minimum of three thermocouples per side, a less desired variation may have fewer thermocouples per cell.

The preferred embodiment of the system would involve 3 or more airflow groups along each side of the smelting cell, where the airflow can be controlled separately in each group by the use of airflow manifolds with airflow control valves on each. Each airflow group would have at least one thermocouple permanently mounted to the shell under a heat exchanger in that group.

A variation of the invention may have only one duct connected to every heat exchanger along the cell. In this case airflow may be controlled per duct only, so no zonal cooling is possible, however the whole side of the cell could be given more or less cooling as required.

A variation may have only one duct connected to every heat exchanger without manifolds, but with every heat exchanger having airflow control via individual airflow control valves, or by installing orifice plates in the suction line on every heat exchanger, which could be changed for smaller or larger orifices to control airflow.

Various types of heat exchangers can be used though we prefer to use an air-cooled heat exchanger to minimise any risk of vaporisation of any liquid coolants in hot spots.

Whilst we prefer a suction-based system—it could be a fan forced system in which pressurised air is pushed into the heat exchangers rather than being pulled through on the preferred arrangement.

1. A method of smelting aluminium in an electrolytic pot, comprising:
providing a plurality of temperature sensors on or adjacent the shell of the electrolytic pot,
providing a plurality of heat exchangers, each heat exchanger located in proximity to one of the temperature sensors to provide localized cooling of the shell of the pot in response to the output of the proximal temperature sensor,
insulating or enhancing heat loss from a portion of the exterior of the shell of the pot depending on the rate of air flow from nil to maximum through the heat exchangers,
monitoring the temperature sensors and if the temperature is above a first threshold value, increasing the localized external cooling, and if the temperature is below a second threshold value, reducing or stopping the localized external cooling.

2. The method of smelting aluminium in an electrolytic pot, as claimed in claim 1, wherein at least some of the heat exchangers have the capability of induced or forced air cooling so that control of the airflow controls the amount of heat extracted from that locality of the pot.

3. The method of smelting aluminium in an electrolytic pot, as claimed in claim 2, wherein the heat exchangers are controlled by the amount of air sucked thorough each heat exchanger.

4. The method of smelting aluminium in an electrolytic pot, as claimed in claim 3, wherein each heat exchanger has one or more ducts leading to a common manifold and control of the rate of cooling is effected by increasing or reducing the rate of airflow through the manifold.

5. The method of smelting aluminium in an electrolytic pot, as claimed in claim 1, wherein the temperature measured by each sensor is monitored and is used to send a control signal to the relevant heat exchanger to correct any shift in temperature.

6. An electrolytic pot for smelting aluminium, comprising:
a carbon lined pot having a metal shell and containing a plurality of anodes and cathodes and in use capable of containing an electrolyte of alumina and additives which is converted by electrolysis to molten aluminium,
wherein the pot has:
a plurality of pot temperature sensors situated on or adjacent the metal shell,
a plurality of heat exchangers on or adjacent the metal shell, with each heat exchanger located in proximity to one of the temperature sensors and capable of providing localised cooling,
at least a portion of the exterior of each heat exchanger is insulated to reduce heat loss therefrom,
means for monitoring the temperature sensors and means for controlling the localised external cooling.

7. The electrolytic pot for smelting aluminium, as claimed in claim 6, wherein each heat exchange does not have a fully enclosed back wall and is clamped to the pot shell.

8. The electrolytic pot for smelting aluminium, as claimed in claim 7, wherein each heat exchanger has an open bottom to allow ambient air to be drawn into the heat exchanger.

9. The electrolytic pot for smelting aluminium, as claimed in claim 8, wherein each heat exchange fully encloses each proximal temperature sensor.

10. The electrolytic pot for smelting aluminium, as claimed in claim 6, wherein at least some of the heat exchangers have outlet air cooling ducts so that control of the airflow controls the amount of heat extracted from that locality of the pot.

11. The electrolytic pot for smelting aluminium, as claimed in claim 10, wherein each outlet duct has a valve for controlling the amount of air exiting the heat exchanger.

12. The electrolytic pot for smelting aluminium, as claimed in claim 10, wherein the heat exchangers are air suction heat exchangers in which all heat exchanger boundaries are substantially sealed against the shell of the electrolytic pot, thereby allowing air to be drawn through the ducts.

13. The electrolytic pot for smelting aluminium, as claimed in claim 10, wherein the heat exchangers have a plurality of ducts leading to a common manifold and control of the rate of cooling can be effected by increasing or reducing the rate of airflow through the ducts and/or the manifold.

14. The electrolytic pot for smelting aluminium, as claimed in claim 6, wherein each pot temperature sensor is a thermocouple.

15. A potline containing a plurality of electrolytic pots for smelting aluminium, each pot as set forth in claim 6.

16. The potline as claimed in claim 15, having a data network and statistical monitoring and alarm system wherein each pot temperature sensor provides an electrical output to a computer monitoring system and means for storing temperature records for each pot temperature sensor to detect heating or cooling trends or temperatures outside preset parameters.

17. The potline as claimed in claim 16, wherein the computer monitoring system can provide both control signals to certain airflow valves to correct thermal imbalances, and alarms and guidance to Pot Operators and Engineers to investigate imbalances on specific pots.
